(19) United States
(12) Patent Application Publication
(10) Pub. No.: US 2026/0071603 A1
(43) Pub. Date: Mar. 12, 2026

(54) IGNITION COIL

(71) Applicant: DENSO CORPORATION, Kariya-city (JP)

(72) Inventor: Takayuki INAGAKI, Obu-city (JP)

(21) Appl. No.: 19/390,037

(22) Filed: Nov. 14, 2025

Related U.S. Application Data
(63) Continuation of application No. PCT/JP2024/008306, filed on Mar. 5, 2024.

(30) Foreign Application Priority Data
May 16, 2023 (JP) 2023-081022

(51) Int. Cl. F02P 13/00; H01F 38/12

(52) U.S. Cl. CPC F02P 13/00; H01F 38/12

(57) ABSTRACT

An ignition coil includes a joint part that is formed of a tubular elastic body. The join part has a distal end mounted to an ignition plug arranged in a plug hole having a bend, and a proximal end mounted to a coil main body part arranged at a proximal-side entrance part of the plug hole which has a greater inner diameter than the bend. On an outer circumferential surface of a main tubular portion opposed to the bend, there are formed first ribs each extending along an axis of the joint part. On an outer circumferential surface of a proximal-side tubular portion, there are formed second ribs each extending along the axis of the joint part. When viewed along the axis of the joint part, a maximum value of a first rib diameter and a maximum value of a second rib diameter satisfy the relationship of d2 > d1.

### CROSS-REFERENCE TO RELATED APPLICATIONS

The present application is a continuation application of International Application No. PCT/JP2024/008306 filed on March 5, 2024, which is based on and claims priority from Japanese Patent Application No. 2023-081022 filed on May 16, 2023. The entire contents of these applications are incorporated by reference into the present application.

### BACKGROUND

### Technical Field

The present disclosure relates to ignition coils for use in ignition apparatuses of internal combustion engines.

### Description of Related Art

Ignition apparatuses provided in internal combustion engines generally include an ignition coil for applying a high voltage to an ignition plug facing a combustion chamber. In recent years, highly efficient internal combustion engines have been required to be more compact in order to improve fuel efficiency. Moreover, the internal structures of cylinder heads to which ignition apparatuses are provided have become increasingly complex; and there are increasing constraints on those parts of cylinder heads to which ignition apparatuses are assembled. Therefore, investigations have been conducted to form plug holes, in which ignition plugs are placed, in a bent shape and thereby make the assembly structures of ignition coils more compact.

In this case, it is required to configure joint parts of ignition coils, which are fitted to ignition plugs, with flexible one-piece molded products that are formed, for example, of rubber and to mount the joint parts in a bent state inside the plug holes. For example, Japanese Patent No. JP 4267042 B2 discloses an ignition coil apparatus for an internal combustion engine which includes a cylindrical plug boot that serves as a joint part. The plug boot, which is electrically insulative and flexible, has formed therein a thin wall part that is opposed to a bend of a plug hole. The thin wall part can be easily bent when an ignition plug is inserted into the plug boot in the plug hole that is bent in the middle and has a constant diameter. Furthermore, a radially-protruding guard part is provided at a distal end of the plug boot to facilitate the alignment of central axes of the plug boot and the ignition plug and thereby improve the insertability.

### SUMMARY

When mounting an ignition apparatus in a bent plug hole, it is necessary to insert a tool into the plug hole. Therefore, in practice, it is difficult to set the plug hole diameter to be constant as disclosed in the aforementioned patent document; and the inner diameter of the plug hole on the plug hole entrance side of the bend is generally greater than that on the ignition plug side of the bend. In this case, if the entire joint part is formed of an elastic material, local compression or deflection is likely to occur due to the compressive force applied during the insertion of the ignition plug. Therefore, it is difficult to mount the joint part while simultaneously suppressing axial misalignment at the bend of the plug hole and on both the distal and proximal sides thereof. Moreover, with the shape of the joint part having a thin wall part as disclosed in the aforementioned patent document, if the thin wall part is brought into contact with the bend of the plug hole by, for example, axial misalignment, wear may occur due to vibration or the like after the ignition coil has been mounted to an engine; thus, the withstand voltage of the ignition coil may be lowered.

The present disclosure has been accomplished in view of the above problems.

According to the present disclosure, there is provided an ignition coil configured to supply a high voltage to an ignition plug arranged in a plug hole having a bend, the ignition coil comprising:

a coil main body part configured to be arranged at a proximal-side entrance part of the plug hole, the proximal-side entrance part having an inner diameter greater than that of the bend; and

a joint part formed of a tubular elastic body that is bendable and deformable, the join part having a proximal end mounted to the coil main body part and a distal end to be mounted to the ignition plug,

wherein:

the joint part has a plurality of first ribs formed on an outer circumferential surface of a main tubular portion of the joint part, each of the first ribs extending along an axis of the joint part, the main tubular portion having a part thereof to be opposed to the bend of the plug hole;

the first ribs are arranged continuously, on both a distal side and a proximal side of the part of the main tubular portion which is to be opposed to the bend of the plug hole, toward both a distal end and a proximal end of the main tubular portion;

the joint part also has a plurality of second ribs formed on an outer circumferential surface of a proximal-side tubular portion of the joint part, each of the second ribs also extending along the axis of the joint part, the proximal-side tubular portion being located on a proximal side of the main tubular portion; and

when viewed along the axis of the joint part, a maximum value d1 of a first rib diameter, which is represented by the diameter of an imaginary circumscribing

circle having its center located on the axis and circumscribing tips of the first ribs, and a maximum value d2 of a second rib diameter, which is represented by the diameter of an imaginary circumscribing circle having its center located on the axis and circumscribing tips of the second ribs, satisfy the relationship of d2 > d1.

With the above configuration of the ignition coil according to the present disclosure, the rigidity of the joint part is improved by the first ribs formed on the main tubular portion of the joint part and the second ribs formed on the proximal-side tubular portion of the joint part. Moreover, with the first and second ribs, each of which extends along the axis of the joint part, serving as guides, the insertability of the joint part into the plug hole is improved. Consequently, the main tubular portion can be bent and deformed along the shape of the bent plug hole while suppressing axial misalignment; and the first ribs are arranged at a location facing the bend of the plug hole and coaxially with the plug hole. Furthermore, on the side of the proximal-side entrance part whose inner diameter is greater than that of the bend, there is arranged the proximal-side tubular portion on which the second ribs, whose maximum diameter is greater than that of the first ribs, are formed. Consequently, it becomes possible to suppress axial misalignment during the insertion of the joint part into the plug hole and displacement due to vibration or the like, thereby suppressing deterioration of characteristics due to wear.

In summary, according to the present disclosure, it becomes possible to provide the ignition coil which, when being mounted into the bent plug hole, can suppress axial misalignment while maintaining the insertability of the joint part, thereby improving the assemblability and wear resistance.

### BRIEF DESCRIPTION OF THE DRAWINGS

FIG. 1 is a partially cross-sectional front view of an ignition apparatus with an ignition coil in an assembled state according to a first embodiment.

FIG. 2 is a partially cross-sectional front view of the ignition apparatus illustrating an assembly process of the ignition coil according to the first embodiment.

FIG. 3 is a front view of the ignition coil according to the first embodiment.

FIG. 4 show transverse cross-sectional views of the ignition coil according to the first embodiment, i.e., a cross-sectional view taken along the line I-I in FIG. 3 and a cross-sectional view taken along the line II-II in FIG. 3.

FIG. 5 show transverse cross-sectional views of the ignition coil according to the first embodiment, i.e., a cross-sectional view taken along the line III-III in FIG. 3 and a cross-sectional view taken along the line IV-IV in FIG. 3.

FIG. 6 is a longitudinal cross-sectional view showing part of the ignition coil according to the first embodiment.

FIG. 7 is a diagram illustrating an assembly process of an ignition coil according to a first comparative example.

FIG. 8 is another diagram illustrating the assembly process of the ignition coil according to the first comparative example.

FIG. 9 is a cross-sectional view illustrating an assembled state of an ignition coil according to a second comparative example.

### DESCRIPTION OF EMBODIMENTS

### First Embodiment

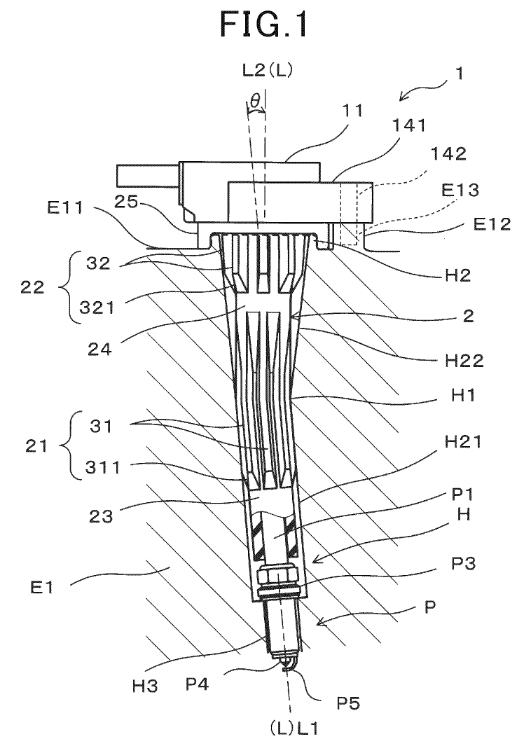

An embodiment embodying an ignition coil according to the present disclosure will be described with reference to FIGS. 1 to 6. As shown in FIG. 1, an ignition coil 1 is electrically connected to an ignition plug P provided in an internal combustion engine such as a vehicle engine, and is used to supply a high voltage to the ignition plug P. The ignition plug P is arranged in a plug hole H having a bend H1. The ignition coil 1 includes a coil main body part 11 arranged at a proximal-side entrance part H2 of the plug hole H, and a joint part 2.

The plug hole H, which is formed in a cylinder head E1, has a bent shape with the bend H1 formed in the middle. The proximal-side entrance part H2 of the plug hole H has an inner diameter greater than that of the bend H1. The joint part 2 is formed of a tubular elastic body that is bendable and deformable. In the plug hole H, the joint part 2 is mounted at its proximal end to the coil main body part 11, and is mounted at its distal end to the ignition plug P.

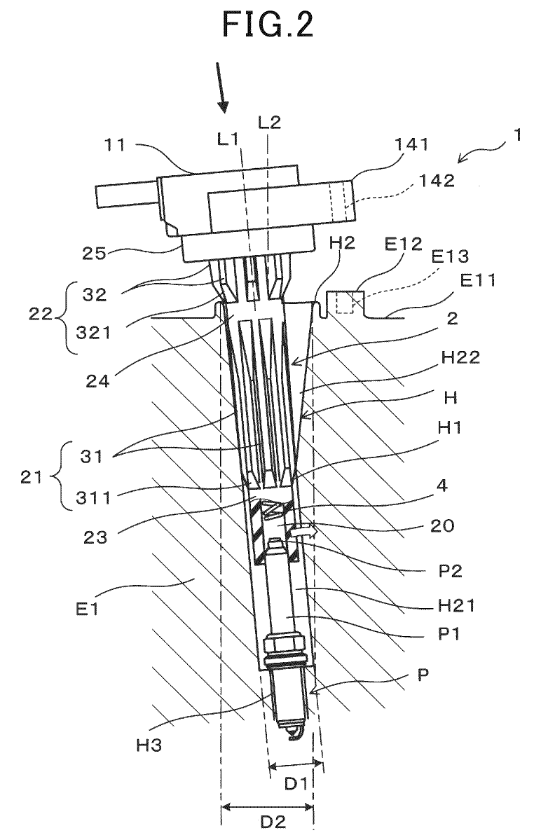

The proximal side is the plug hole entrance side when the joint part 2 is inserted into the plug hole H and mounted to the ignition plug P in the extending direction of the bent plug hole H as shown in FIG. 2, and is the side where the coil main body part 11 is arranged. The distal side is the opposite side to the proximal side, and is the side where the ignition plug P is arranged. In the bent plug hole H, the axis L2 on the proximal side of the bend H1 does not coincide with the axis L1 on the distal side of the bend H1; therefore, the extending direction of the plug hole H, which is the direction along the axes L1 and L2, also changes.

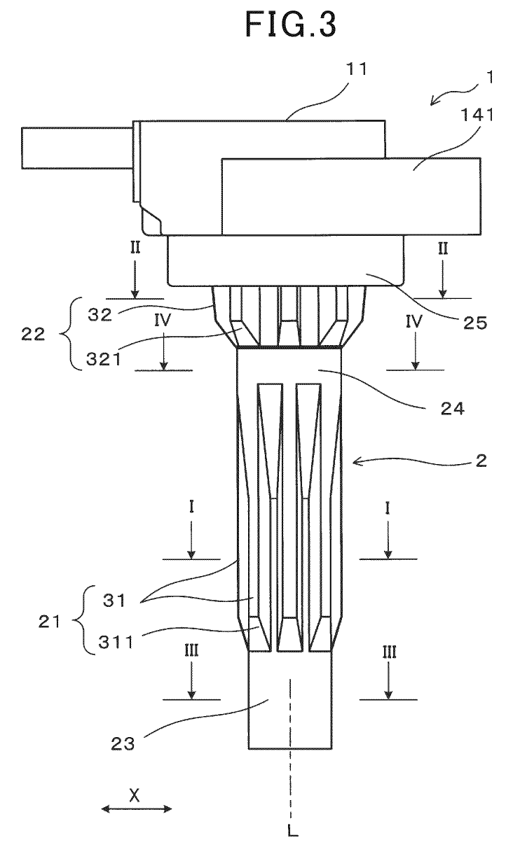

In the assembled state shown in FIG. 1, the joint part 2 has a main tubular portion 21 including a portion facing the bend H1 of the plug hole H, and a proximal-side tubular portion 22 located on the proximal side of the main tubular portion 21. As shown in FIG. 3, on an outer circumferential surface of the main tubular portion 21, there are formed a plurality of first ribs 31 each extending along the axis L of the joint part 2. On the other hand, on an outer circumferential surface of the proximal-side tubular portion 22, there are formed a plurality of second ribs 32 each extending along the axis L of the joint part 2. The first ribs 31 and the second ribs 32 each protrude in a direction perpendicular to the axis L, i.e., protrude outward in a radial direction X of the joint part 2.

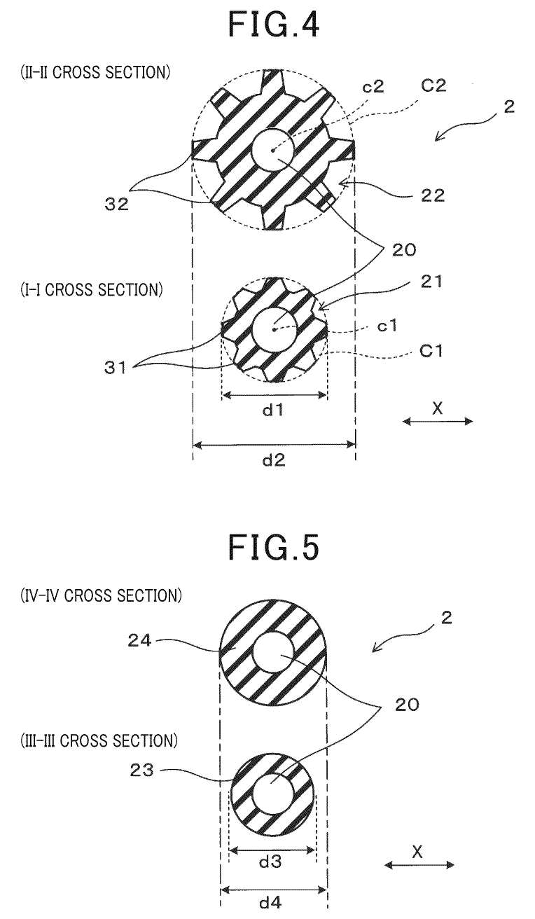

Moreover, as shown in FIG. 4, when viewed in a direction along the axis L, a first rib diameter in the main tubular portion 21 is represented by the diameter of an imaginary circumscribing circle C1 that has its center c1 located on the axis of the main tubular portion 21 and circumscribes the tips of the first ribs 31; and a second rib diameter in the proximal-side tubular portion 22 is represented by the diameter of an imaginary circumscribing circle C2 that has its center c2 located on the axis of the proximal-side tubular portion 22 and circumscribes the tips of the second ribs 32. Furthermore, the maximum value d1 of the first rib diameter and the maximum value d2 of the second rib diameter satisfy the relationship of d2 > d1. That is, the joint part 2 is configured so that the maximum outer diameter of the proximal-side tubular portion 22 is greater than the maximum outer diameter of the main tubular portion 21.

With the above configuration, during the insertion of the joint part 2 of the ignition coil 1 into the bent plug hole H, the first ribs 31 and the second ribs 32 serve as guides, thereby improving the insertability. Moreover, with the first ribs 31 and the second ribs 32, the rigidity of the joint part 2 of the ignition coil 1 is improved, thereby making it possible to assemble the ignition coil 1 to the plug hole H while suppressing axial misalignment. In addition, the first ribs 31 are arranged to face the bend H1 of the plug hole H, while the second ribs 32, whose maximum outer diameter is greater than that of the first ribs 31, are arranged on the plug hole entrance side where the inner diameter of the plug hole H is greater than that at the bend H1.

Specifically, the first ribs 31 may be arranged continuously on both the distal and proximal sides of that portion of the joint part 2 which faces the bend H1 of the plug hole H. In this case, when the main tubular portion 21 including the first ribs 31 is bent and deformed according to the bent shape of the plug hole H, the first ribs 31 are located astride the bend H1 of the plug hole H, thereby enhancing the effects of suppressing axial misalignment during the insertion of the joint part 2 into the plug hole H and displacement due to vibration or the like.

On the other hand, the second ribs 32 may be arranged continuously from the proximal side to the distal side, facing a proximal-side end part of the plug hole H which includes the proximal-side entrance part H2. Consequently, the axial rigidity of the joint part 2 on the proximal side is improved, thereby enhancing the effects of suppressing axial misalignment during the insertion of the joint part 2 into the plug hole H and displacement due to vibration or the like. Moreover, when assembling the coil main body part 11 to the plug hole H after the insertion of the joint part 2 into the plug hole H, axial misalignment is suppressed, thereby improving the assemblability. The shape of the joint part 2 will be described in more detail later.

Next, the assembly structure of the ignition coil 1 to the plug hole H will be described in detail. FIG. 2 shows the state of the ignition coil 1 before the joint part 2 is bent during the assembly of the ignition coil 1 to the plug hole H. On the other hand, FIG. 1 shows the state of the ignition coil 1 after being assembled to the plug hole H. As shown in FIGS. 1 and 2, the plug hole H, in which the joint part 2 of the ignition coil 1 is accommodated, has a distal-side half part H21 located on the distal side of the bend H1 and a proximal-side half part H22 located on the proximal side of the bend H1. The distal-side half part H21 is a circular hole having a substantially constant diameter and extending to a mounting portion of the ignition plug P. On the other hand, the proximal-side half part H22 is a tapered hole whose diameter gradually increases from the bend H1 toward the proximal side. The bend H1 is provided at an intermediate position in the extending direction of the plug hole H. It should be noted that the bend H1 may be located either distalward or proximalward from the position thereof shown in the drawings.

The plug hole H is formed at a predetermined position in the cylinder head E1 for each cylinder of the engine. The axis L1 of the distal-side half part H21 is inclined with respect to the axis L2 of the proximal-side half part H22. The axis L2 extends in a direction perpendicular to a first surface E11 of the cylinder head E1 where the proximal-side half part H22 opens. The bending angle of the bend H1 is represented by the inclination angle θ of the axis L1 with respect to the axis L2 (see FIG. 1), which is equal to the taper angle of the proximal-side half part H22 in the present embodiment. That is, in the left half of the cross section shown in FIGS. 1 and 2, the inner circumferential surface of the proximal-side half part H22 continues from the inner circumferential surface of the distal-side half part H21 without bending; in contrast, in the right half of the cross section, the bend H1 is formed.

Moreover, a first inner diameter D1 of the plug hole H at the distal-side half part H21 and a second inner diameter D2 of the plug hole H at the proximal-side entrance part H2 that opens on the proximal side of the proximal-side half part H22 satisfy the relationship of D2 > D1 (see FIG. 2). Therefore, the joint part 2 has the main tubular portion 21 located astride the bend H1 of the plug hole H and the proximal-side tubular portion 22 located on the proximal side of the main tubular portion 21. The first ribs 31 and the second ribs 32 are provided respectively in the main tubular portion 21 and the proximal-side tubular portion 22. The main tubular portion 21 is opposed to both a portion of the distal-side half part H21 of the plug hole H and a portion of the proximal-side half part H22 of the plug hole H which are continuous with each other with the bend H1 interposed therebetween. On the other hand, the proximal-side tubular portion 22 is opposed to a portion of the proximal-side half part H22 of the plug hole H which includes the proximal-side entrance part H2.

As shown in FIG. 1, the ignition plug P is arranged so as to close a distal end hole H3 that continues from the distal-side half part H21. The distal end hole H3 is a circular hole having a substantially constant diameter less than the diameter of the distal-side half part H21. The ignition plug P has its distal end arranged so as to face a combustion chamber (not shown) of the engine. The ignition plug P has an insulator P1, a head terminal P2 (see FIG. 2) protruding from the insulator P1 toward the proximal side, a housing P3 that holds the insulator P1 therein, a center electrode P4 protruding from the insulator P1 toward the distal side, and a ground electrode P5 opposed to the center electrode P4. Moreover, the ignition plug P also has a threaded portion formed in an outer circumferential surface of the housing P3, and a hexagonal portion formed on the proximal side of the threaded portion for engaging with a tool. The ignition plug P is fastened and fixed in the plug hole H.

As shown in FIGS. 3 to 5, the joint part 2 is constituted of a tubular one-piece molded product that is formed entirely of an electrically-insulative elastic material such as rubber. The joint part 2 is configured so that it can be freely elastically deformed according to the shape of the plug hole H and be held in a bent state. The joint part 2 has a straight-shaped distal-side tubular portion 23 formed on the distal side of the main tubular portion 21 and fitted onto a head portion of the insulator P1 of the ignition plug P. The joint part 2 also has a straight-shaped intermediate tubular portion 24 formed between the main tubular portion 21 and the proximal-side tubular portion 22. Each of the distal-side tubular portion 23 and the intermediate tubular portion 24 has a flat cylindrical outer circumferential surface with no ribs formed thereon, and has a substantially constant outer diameter. Moreover, each of the distal-side tubular portion 23 and the intermediate tubular portion 24 has a smaller thickness and a lower rigidity and thus can be more easily elastically deformed than those portions of the joint part 2 which have ribs formed thereon. Furthermore, the outer diameter d3 of the distal-side tubular portion 23 and the outer diameter d4 of the intermediate tubular portion 24 satisfy the relationship of d4 > d3 (see FIG. 5).

As shown in FIG. 2, in a cylindrical hole 20 that axially penetrates the joint part 2, there is accommodated an electroconductive member 4 that electrically connects the coil main body part 11 and the ignition plug P. In the present embodiment, the electroconductive member 4 is constituted of a spring that is elastically deformable in the axial direction. The electroconductive member 4 has its distal end located inside the distal-side tubular portion 23. The distal-side tubular portion 23 has the insulator P1 inserted thereinto from the proximal end of the insulator P1, thereby bringing the electroconductive member 4 into abutment with the head terminal P2. The axial length of the distal-side tubular portion 23 may be suitably set so as to obtain a desired fitting dimension, taking into account the amount of compressive deformation when the head portion of the insulator P1 is inserted into the distal-side tubular portion 23.

As shown in FIG. 4, the first ribs 31, each of which has the shape of a protrusion protruding outward in the radial direction X, are formed respectively at a plurality of locations on the outer circumferential surface of the main tubular portion 21 of the joint part 2. More particularly, in the present embodiment, eight first ribs 31 are formed respectively at eight locations on the outer circumferential surface of the main tubular portion 21 of the joint part 2. The first ribs 31 each have a substantially trapezoidal cross-sectional shape, protrude in a radial fashion, and together form a gear-like external shape. The first ribs 31 extend parallel to each other along the axis L of the joint part 2. Moreover, the first ribs 31 are formed over the entire length from the proximal side to the distal side of the main tubular portion 21, i.e., from the distal end position of the intermediate tubular portion 24 to the proximal end position of the distal-side tubular portion 23 (see FIG. 3).

As shown in FIG. 3, each of the first ribs 31 has, at a distal end thereof, a tapered portion 311 that slopes downward toward the distal side. Therefore, in a distal end part of the main tubular portion 21, the first rib diameter, which is the diameter of the imaginary circumscribing circle C1 shown in FIG. 4, gradually decreases toward the distal side. In the main tubular portion 21 excluding the distal end part thereof, the first rib diameter is substantially constant and has the maximum value d1. Moreover, distal ends of the tapered portions 311 of the first ribs 31 are connected with the distal-side tubular portion 23. Therefore, the minimum value d11 of the first rib diameter is greater than or equal to the outer diameter d3 of the distal-side tubular portion 23 shown in FIG. 5. That is, the following relationship is satisfied: d1 > d11 ≥ d3. In the distal end part of the main tubular portion 21 where the tapered portions 311 of the first ribs 31 are formed, the first rib diameter increases toward the proximal side, approaching the maximum value d1.

As above, each of the first ribs 31 of the main tubular portion 21 has the tapered portion 311 formed at the distal end thereof, so that the main tubular portion 21 as a whole has a tapered shape that narrows toward the distal side, thereby improving the insertability.

The main tubular portion 21 is connected, on the proximal side thereof and with the first rib diameter kept substantially constant at the maximum value d1, with the intermediate tubular portion 24 that has a substantially constant diameter. Moreover, the outer diameter d4 of the intermediate tubular portion 24 shown in FIG. 5 is greater than or equal to the maximum value d1 of the first rib diameter, and is thus greater than the outer diameter d3 of the distal-side tubular portion 23 (i.e., d4 ≥ d1 > d11 ≥ d3). To achieve the above relationship, in an end part of the main tubular portion 21 on the intermediate tubular portion 24 side, those portions of the main tubular portion 21 which are located between the circumferentially adjacent first ribs 31 (i.e., those portions of the main tubular portion 21 where no first ribs 31 are formed) are formed so as to gradually become thicker toward the proximal side and protrude radially outward. Consequently, in the end part of the main tubular portion 21 on the intermediate tubular portion 24 side, the rigidity of the main tubular portion 21 is improved and the protruding height of the first ribs 31 decreases toward the proximal side.

It is preferable that the first ribs 31 be evenly arranged at substantially equal intervals in the circumferential direction on the outer circumferential surface of the main tubular portion 21. The protruding ends of the first ribs 31 face the inner circumferential surface of the plug hole H, which is located outside the first ribs 31 in the radial direction X, through a gap formed therebetween. The larger the gap, the more the insertability is improved. However, there is a risk of axial misalignment. Therefore, it is preferable that in the vicinity and on the distal side of the bend H1, the inner circumferential surface of the plug hole H and the first ribs 31 be located close to each other with a slight gap, which is within a range that does not impair the insertability, formed therebetween. In this case, a first inner diameter D1 (see FIG. 2) in the distal-side half part H21 of the plug hole H and the maximum value d1 (see FIG. 4) of the first rib diameter satisfy the relationship of D1 > d1.

The axial length of the main tubular portion 21 on which the first ribs 31 are arranged is not necessarily limited, but may be suitably set depending on the position of the bend H1 in the plug hole H. Specifically, taking into account the length of the distal-side tubular portion 23 mounted to the ignition plug P, the length of the proximal-side tubular portion 22 and the like, the proximal end position of the first ribs 31 may be set to, for example, a position within a range of 30% to 80% of the length of the joint part 2 from the distal end position of the joint part 2 (i.e., the distal end position of the distal-side tubular portion 23). Moreover, in terms of improving the rigidity of the joint part 2, it is preferable that the axial length of the first ribs 31 be set as long as possible within the above range so that the proximal end position of the first ribs 31 is on the proximal side of the bend H1 of the plug hole H. In addition, a seal part 25 is generally provided, on the proximal side of the joint part 2, integrally with the joint part 2. In this case, the length of the joint part 2 (hereinafter, to be referred to as the joint length as appropriate) is the length including the seal part 25 (i.e., the axial length from the distal end position of the distal-side tubular portion 23 to the proximal end position of the seal part 25). The seal part 25 will be described in detail later.

The number of the first ribs 31 is not necessarily limited, but in terms of improving the insertability as guides during the insertion of the joint part 2 into the plug hole H, it is preferable for the first ribs 31 to be formed at three or more locations on the outer circumferential surface of the main tubular portion 21. For example, the number of the first ribs 31 may be suitably set, within a range of 4 to 10 locations on the outer circumferential surface of the main tubular portion 21, according to the outer diameter of the proximal end or distal end of the main tubular portion 21, the inner diameter of the plug hole H and the like, so as to obtain the desired insertability and rigidity. Similarly, the width and protruding height of the first ribs 31 may also be suitably set.

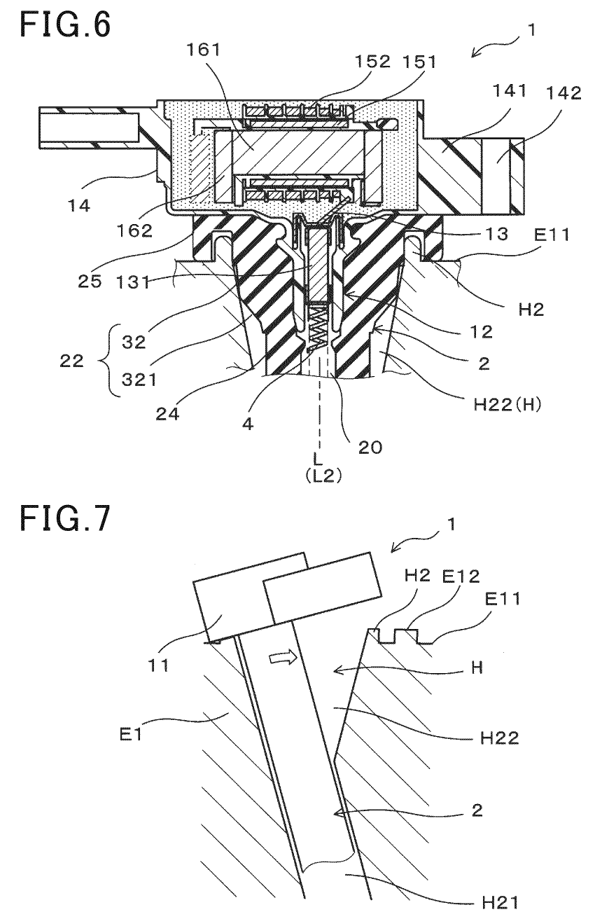

As shown in FIG. 6, on the proximal side of the plug hole H, the joint part 2 is fitted onto a high-voltage tower part 12 that protrudes from the coil main body part 11. The high-voltage tower part 12 holds a high-voltage terminal 13 and a resistor 131 therein. The proximal-side tubular portion 22 of the joint part 2 has the high-voltage tower part 12 inserted thereinto from the distal end of the high-voltage tower part 12, so that the high-voltage tower part 12 is inserted into the cylindrical hole 20 and a proximal end of the electroconductive member 4 is brought into abutment with the resistor 131. Consequently, the high-voltage terminal 13 and the electroconductive member 4 are electrically connected with each other via the resistor 131.

The coil main body part 11 has an electrically-insulative coil case 14 arranged on the proximal side of the high-voltage tower part 12. In the coil case 14, there are accommodated: a primary coil 151 and a secondary coil 152 that are arranged coaxially with each other; a central core 161 arranged inside the coils; and an outer peripheral core 162 arranged on the outer periphery of the coils. Consequently, a high voltage generated in the secondary coil 152 can be outputted from the high-voltage terminal 13 and then applied to the ignition plug P via the electroconductive member 4.

As shown in FIG. 4, the second ribs 32, each of which protrudes outward in the radial direction X, are formed respectively at a plurality of locations on the outer circumferential surface of the proximal-side tubular portion 22 of the joint part 2. More particularly, in the present embodiment, eight second ribs 32 are formed respectively at eight locations on the outer circumferential surface of the proximal-side tubular portion 22 of the joint part 2. The second ribs 32 each have a substantially trapezoidal cross-sectional shape, protrude in a radial fashion, and together form a gear-like external shape. The second ribs 32 extend parallel to each other along the axis L of the joint part 2. Moreover, the second ribs 32 are formed over the entire length from the proximal side to the distal side of the proximal-side tubular portion 22, i.e., to the proximal end position of the intermediate tubular portion 24.

As shown in FIG. 3, each of the second ribs 32 has, at a distal end thereof, a tapered portion 321 that slopes downward toward the distal side. Therefore, in a distal end part of the proximal-side tubular portion 22, the second rib diameter, which is the diameter of the imaginary circumscribing circle C2 shown in FIG. 4, gradually decreases toward the distal side. In the proximal-side tubular portion 22 excluding the distal end part thereof, the second ribs 32 have a gentle slope; and the second rib diameter has the maximum value d2 at the proximal end of the proximal-side tubular portion 22. It is preferable that the second ribs 32 have a slope equal to the taper angle of the proximal-side half part H22 so that the proximal-side tubular portion 22 comes into surface contact with the inner circumferential surface of the plug hole H on the proximal side. The slope of the second ribs 32 at the tapered portions 321 thereof is greater than that at the proximal-side tubular portion 22 on the proximal side of the tapered portions 321. Moreover, distal ends of the tapered portions 321 of the second ribs 32 are connected with the intermediate tubular portion 24. Therefore, the minimum value d21 of the second rib diameter is greater than or equal to the outer diameter d4 of the intermediate tubular portion 24 shown in FIG. 5. That is, the following relationship is satisfied: d2 > d21 ≥ d4. In the distal end part of the proximal-side tubular portion 22 where the tapered portions 321 of the second ribs 32 are formed, the second rib diameter increases toward the proximal side, approaching the maximum value d2.

As above, each of the second ribs 32 of the proximal-side tubular portion 22 has the tapered portion 321 formed at the distal end thereof, so that the proximal-side tubular portion 22 as a whole has a tapered shape that narrows toward the distal side, thereby improving the insertability.

It is preferable that the second ribs 32 be evenly arranged at substantially equal intervals in the circumferential direction on the outer circumferential surface of the proximal-side tubular portion 22. The protruding ends of the second ribs 32 face the inner circumferential surface of the plug hole H, which is located outside the second ribs 32 in the radial direction X, through a gap formed therebetween. The larger the gap, the more the insertability is improved. However, there is a risk of axial misalignment. Therefore, it is preferable that the inner circumferential surface of the proximal-side half part H22 on the plug hole entrance side and the second ribs 32 be located close to each other with a slight gap, which is within a range that does not impair the insertability, formed therebetween. In this case, the second inner diameter D2 at the proximal-side entrance part H2 of the plug hole H and the maximum value d2 of the second rib diameter satisfy the relationship of D2 > d2 (> D1 > d4 ≥ d1 > d11 ≥ d3).

The axial length of the proximal-side tubular portion 22 on which the second ribs 32 are arranged is not necessarily limited; however, it is preferable to set the axial length of the proximal-side tubular portion 22 according to the length of the joint part 2 including the seal part 25 so that the axial length of the first ribs 31 located astride the bend H1 of the plug hole H becomes greater than the axial length of the proximal-side tubular portion 22. Specifically, in order to obtain the effect of axial alignment on the plug hole entrance side of the proximal-side half part H22 of the plug hole H, the distal end position of the second ribs 32 inserted into the proximal-side entrance part H2 of the plug hole H may be set to, for example, a position within a range of 1% to 20% of the length of the joint part 2 from the proximal end position of the joint part 2 (i.e., the proximal end position of the seal part 25) according to the arrangement of the first ribs 31 and the like. It is preferable to suitably set, within a range in which the axial length of the first ribs 31 can be secured, the distal end position of the second ribs 32 to a position of 5% or more of the length of the joint part 2 from the proximal end position of the joint part 2. In this case, it will be possible to secure the length for which the proximal-side tubular portion 22 makes surface contact with the inner circumferential surface of the plug hole H in the vicinity of the proximal-side entrance part H2, thereby enhancing the function of the second ribs 32 as guides.

The number of the second ribs 32 is not necessarily limited, but in terms of improving the insertability as guides during the insertion of the joint part 2 into the plug hole H, it is preferable for the second ribs 32 to be formed at three or more locations on the outer circumferential surface of the proximal-side tubular portion 22. For example, the number of the second ribs 32 may be suitably set, within a range of 4 to 10 locations on the outer circumferential surface of the proximal-side tubular portion 22, according to the shape of the proximal-side half part H2 of the plug hole H in which the proximal-side tubular portion 22 is arranged, the inner diameter of the proximal-side entrance part H2 of the plug hole H and the like, so as to obtain the desired insertability and rigidity. Similarly, the width and protruding height of the second ribs 32 may also be suitably set.

As shown in FIGS. 1 and 2, the seal part 25 is arranged, on the proximal side of the plug hole H, between the proximal-side entrance part H2 and the coil main body part 11. The seal part 25 is formed of rubber, and is formed integrally with the proximal end of the proximal-side tubular portion 22 of the joint part 2, constituting a part of the joint part 2. In this case, the seal part 25 may be formed so as to protrude, in a flange shape, outward in the radial direction X from the proximal end of the proximal-side tubular portion 22 and thereby cover the proximal-side entrance part H2 of the plug hole H. The proximal-side entrance part H2 is formed, on the first surface E11 of the cylinder head E1 where the proximal end of the plug hole H opens, so as to protrude in annular shape from the first surface E11. The proximal-side entrance part H2 functions as a locking part that locks the seal part 25. A protruding end of the seal part 25, which is bent to have a L-shaped cross section, is locked to the proximal-side entrance part H2, so that the proximal-side opening of the plug hole H can be sealed by the seal part 25.

In the coil main body part 11, there is formed a mounting flange part 141 that protrudes from a side of the coil case 14. Moreover, in the mounting flange part 141, there is formed a through-hole 142 through which a bolt is inserted. A support base part 13 is formed, on the first surface E11 of the cylinder head E1 which faces the mounting flange part 141, to protrude from the first surface E11. Furthermore, in the support base part 13, there is formed a threaded hole E13. With above configuration, the coil main body part 11 can be fixed, by placing the mounting flange part 141 on the support base part E12 and fastening a bolt (not shown), to the proximal end of the plug hole H via the seal part 25; consequently, the plug hole H can be hermetically sealed by the seal part 25.

The ignition coil 1 may be assembled to the plug hole H in, for example, the following way. First, as shown in FIG. 2, the joint part 2, whose proximal end is fitted to the coil main body part 11, is inserted from the proximal-side entrance part H2 of the plug hole H toward the distal side into the plug hole H in which the ignition plug P is mounted. Specifically, the joint part 2 is inserted coaxially with the axis L1 of the distal-side half part H21 of the plug hole H, with the first ribs 31, which are formed on the main tubular portion 21, functioning as guides. Moreover, with the tapered portions 311 formed respectively at the distal ends thereof, the first ribs 31 are prevented from getting caught during the insertion of the joint part 2 into the plug hole H. In this case, the insertion force will not increase even if the difference between the maximum value d1 of the first rib diameter and the inner diameter D1 of the distal-side half part H21 of the plug hole H is reduced; moreover, the rigidity of the joint part 2 is improved, thereby facilitating the axial alignment between the joint part 2 and the plug hole H. Consequently, the distal-side tubular portion 23 of the joint part 2 can have the ignition plug P coaxially inserted thereinto.

Next, the main tubular portion 21 of the joint part 2 is further inserted toward the distal side of the plug hole H while being bent, at the bend H1 of the plug hole H, along the bent shape of the plug hole H. Consequently, the main tubular portion 21 of the joint part 2 can be bent and deformed such that: on the distal side of the joint part 2, the distal-side tubular portion 23 is kept coaxial with the ignition plug P; and on the proximal side of the bend H1, the axis L of the first ribs 31 is kept coaxial with the axis L2 of the proximal-side half part H22 of the plug hole H. Then, on the proximal side of the plug hole H, the proximal-side tubular portion 22 of the joint part 2 is mounted into the proximal-side entrance part H2 of the plug hole H, with the second ribs 32 functioning as guides. In this case, by the tapered portions 321 formed respectively at the distal ends of the second ribs 32, the insertability is improved; and the difference between the maximum value d2 of the second rib diameter and the inner diameter D2 of the proximal-side half part H22 can be reduced, thereby restricting the proximal-side tubular portion 22 of the joint part 2 to a coaxial position with the proximal-side half part H22.

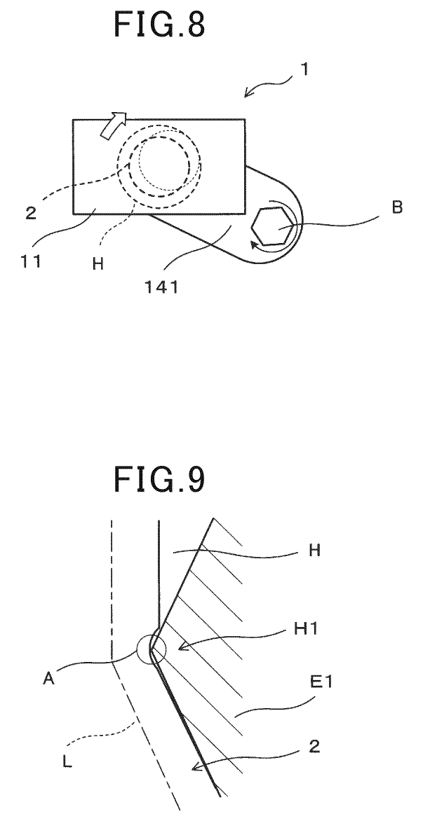

FIG. 7 illustrates a first comparative example in which the joint part 2 has no second ribs 32, and has a constant diameter from a portion thereof facing the bend H1 of the plug hole H to the proximal end thereof. With this configuration, it is difficult to carry out the axial alignment between the joint part 2 and the proximal-side half part H22 of the plug hole H when assembling the joint part 2 to the proximal-side opening edge of the plug hole H while bending the joint part 2 along the bent shape of the plug hole H (e.g., in the direction indicated by the arrow in FIG. 7). Moreover, with this configuration, as shown in FIG. 8, the difference between the inner diameter D2 of the proximal-side entrance part H2 and the outer diameter of the joint part 2 becomes large. Consequently, when a mounting bolt B is tightened and fixed to the mounting flange part 141 of the coil main body part 11, a rotational force acts (e.g., in the direction indicated by the arrow in FIG. 8) so that it becomes easy for axial misalignment of the joint part 2 to occur. As a result, it becomes necessary to provide a rotation stopper or the like to suppress displacement of the coil main body part 11.

FIG. 9 illustrates a second comparative example in which a portion of the joint part 2 is thin-walled. With this configuration, the joint part 2 can be easily deformed along the bent shape of the plug hole H; however, upon the joint part 2 being brought into contact with the bend H1 of the plug hole H, the contact portion (e.g., the portion A shown in FIG. 9) of the joint part 2 with the bend H1 may become worn. For example, in a state of the ignition coil 1 having been mounted to an engine, if the contact portion of the joint part 2 is displaced due to vibration or the like while being kept in contact with the bend H1, the thickness of the contact portion may gradually decrease due to wear, resulting in a decrease in the withstand voltage of the ignition coil 1.

In contrast, the joint part 2 according to the present embodiment has the first ribs 31 opposed to the bend H1 of the plug hole H and the second ribs 32 opposed to the proximal-side entrance part H2. Consequently, it becomes possible to suppress axial misalignment over the entire length of the joint part 2. Moreover, with the second ribs 32 arranged at the proximal-side entrance part H2, it becomes possible to restrict the joint part 2 to be coaxial with the plug hole H, thereby eliminating the need for a rotation stopper during the assembly of the ignition coil 1 to the plug hole H.

Furthermore, with the first ribs 31 and the second ribs 32, the rigidity of the joint part 2 is improved so that even if the first ribs 31 are brought into contact with the bend H1 of the ignition hole H, displacement of the joint part 2 due to vibration or the like can be suppressed. Moreover, even if displacement of the joint part 2 occurs, only the first ribs 31 extending in the axial direction make contact with the bend H1 of the ignition hole H. Consequently, it becomes possible to prevent the thickness of the main body of the main tubular portion 21 from being decreased due to wear; thus, it becomes possible to prevent the withstand voltage of the ignition coil 1 from being lowered.

### Other Embodiments

In the above-described first embodiment, the electroconductive member 4 arranged inside the joint part 2 is constituted of a spring and electrically connected with the high-voltage terminal 13 via the resistor 131 of the high-voltage tower part 12. However, the electroconductive member 4 may be constituted of any electroconductive member that can be bent and deformed together with the joint part 2. Moreover, in the above-described first embodiment, the ignition coil 1 is applied to a vehicle engine. However, the ignition coil 1 may alternatively be applied to an internal combustion engine of a cogeneration system or the like. In addition, it should be noted that among the reference signs used in the first and subsequent embodiments, unless otherwise specified, the same reference signs as those used in the previous embodiment(s) designate the same components as those in the previous embodiment(s).

The present disclosure is not limited to the above-described embodiments, but can also be implemented through various modifications to the above-described embodiments without departing from the gist of the present disclosure. For example, the configuration of the coil main body part 11 of the ignition coil 1 and the connection structure of the coil main body part 11 with the joint part 2 may be suitably modified in various ways.

The following notes summarize the features of the present disclosure.

### First Note

An ignition coil (1) configured to supply a high voltage to an ignition plug (P) arranged in a plug hole (H) having a bend (H1), the ignition coil comprising:

a coil main body part (11) configured to be arranged at a proximal-side entrance part (H2) of the plug hole, the proximal-side entrance part having an inner diameter greater than that of the bend; and

a joint part (2) formed of a tubular elastic body that is bendable and deformable, the join part having a proximal end mounted to the coil main body part and a distal end to be mounted to the ignition plug,

wherein:

the joint part has a plurality of first ribs (31) formed on an outer circumferential surface of a main tubular portion (21) of the joint part, each of the first ribs extending along an axis (L) of the joint part, the main tubular portion having a part thereof to be opposed to the bend of the plug hole;

the first ribs are arranged continuously, on both a distal side and a proximal side of the part of the main tubular portion which is to be opposed to the bend of the plug hole, toward both a distal end and a proximal end of the main tubular portion;

the joint part also has a plurality of second ribs (32) formed on an outer circumferential surface of a proximal-side tubular portion (22) of the joint part, each of the second ribs also extending along the axis of the joint part, the proximal-side tubular portion being located on a proximal side of the main tubular portion; and

when viewed along the axis of the joint part, a maximum value d1 of a first rib diameter, which is represented by the diameter of an imaginary circumscribing circle (C1) having its center (c1) located on the axis and circumscribing tips of the first ribs, and a maximum value d2 of a second rib diameter, which is represented by the diameter of an imaginary circumscribing circle (C2) having its center (c2) located on

the axis and circumscribing tips of the second ribs, satisfy the relationship of d2 > d1.

### Second Note

The ignition coil according to the first note, wherein the first ribs are formed over an entire length of the main tubular portion and configured to be deformed, at the part of the main tubular portion which is to be opposed to the bend of the plug hole, into a shape along the bend of the plug hole.

### Third Note

The ignition coil according to the first or second note, wherein each of the first ribs has, at a distal end thereof, a tapered portion (311) where the first rib diameter decreases toward the distal side.

### Fourth Note

The ignition coil according to any one of the first to third notes, wherein the second ribs are arranged continuously from a proximal side to a distal side, so as to face a proximal-side end part of the plug hole which includes the proximal-side entrance part.

### Fifth Note

The ignition coil according to any one of the first to fourth notes, wherein each of the second ribs has, at a distal end thereof, a tapered portion (321) where the second rib diameter decreases toward the distal side.

### Sixth Note

The ignition coil according to any one of the first to fifth notes, wherein:

the maximum value d1 of the first rib diameter and a first inner diameter D1, which is the inner diameter of the plug hole at the bend, satisfy the relationship of D1 > d1; and

the maximum value d2 of the second rib diameter and a second inner

diameter D2, which is the inner diameter of the plug hole at the proximal-side entrance part, satisfy the relationship of D2 > d2.

### Seventh Note

The ignition coil according to any one of the first to sixth notes, wherein:

the joint part further has a straight-shaped distal-side tubular portion (23) formed on the distal side of the main tubular portion so as to be fitted onto a head portion of the ignition plug; and

an outer diameter d3 of the distal-side tubular portion and the maximum value d1 and a minimum value d11 of the first rib diameter satisfy the relationship of d1 > d11 ≥ d3.

### Eighth Note

The ignition coil according to the seventh note, wherein:

the joint part further has a straight-shaped intermediate tubular portion (24) formed between the main tubular portion and the proximal-side tubular portion; and

an outer diameter d4 of the intermediate tubular portion and the maximum value d2 and a minimum value d21 of the second rib diameter satisfy the relationship of d2 > d21 ≥ d4.

### Ninth Note

The ignition coil according to the eighth note, wherein the outer diameter d3 of the distal-side tubular portion and the outer diameter d4 of the intermediate tubular portion satisfy the relationship of d4 > d3.

While the present disclosure has been described pursuant to the above embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. An ignition coil configured to supply a high voltage to an ignition plug arranged in a plug hole having a bend, the ignition coil comprising:
a coil main body part configured to be arranged at a proximal-side entrance part of the plug hole, the proximal-side entrance part having an inner diameter greater than that of the bend; and
a joint part formed of a tubular elastic body that is bendable and deformable, the join part having a proximal end mounted to the coil main body part and a distal end to be mounted to the ignition plug,
wherein:
the joint part has a plurality of first ribs formed on an outer circumferential surface of a main tubular portion of the joint part, each of the first ribs extending along an axis of the joint part, the main tubular portion having a part thereof to be opposed to the bend of the plug hole;
the first ribs are arranged continuously, on both a distal side and a proximal side of the part of the main tubular portion which is to be opposed to the bend of the plug hole, toward both a distal end and a proximal end of the main tubular portion;
the joint part also has a plurality of second ribs formed on an outer circumferential surface of a proximal-side tubular portion of the joint part, each of the second ribs also extending along the axis of the joint part, the proximal-side tubular portion being located on a proximal side of the main tubular portion; and
when viewed along the axis of the joint part, a maximum value d1 of a first rib diameter, which is represented by the diameter of an imaginary circumscribing circle having its center located on the axis and circumscribing tips of the first ribs, and a maximum value d2 of a second rib diameter, which is represented by the diameter of an imaginary circumscribing circle having its center located on the axis and circumscribing tips of the second ribs, satisfy the relationship of d2 > d1.

2. The ignition coil as set forth in claim 1, wherein the first ribs are formed over an entire length of the main tubular portion and configured to be deformed, at the part of the main tubular portion which is to be opposed to the bend of the plug hole, into a shape along the bend of the plug hole.

3. The ignition coil as set forth in claim 2, wherein each of the first ribs has, at a distal end thereof, a tapered portion where the first rib diameter decreases toward the distal side.

4. The ignition coil as set forth in claim 1, wherein the second ribs are arranged continuously from a proximal side to a distal side, so as to face a proximal-side end part of the plug hole which includes the proximal-side entrance part.

5. The ignition coil as set forth in claim 4, wherein each of the second ribs has, at a distal end thereof, a tapered portion where the second rib diameter decreases toward the distal side.

6. The ignition coil as set forth in claim 1, wherein:
the maximum value d1 of the first rib diameter and a first inner diameter D1, which is the inner diameter of the plug hole at the bend, satisfy the relationship of D1 > d1; and
the maximum value d2 of the second rib diameter and a second inner diameter D2, which is the inner diameter of the plug hole at the proximal-side entrance part, satisfy the relationship of D2 > d2.

7. The ignition coil as set forth in claim 6, wherein:
the joint part further has a straight-shaped distal-side tubular portion formed on the distal side of the main tubular portion so as to be fitted onto a head portion of the ignition plug; and
an outer diameter d3 of the distal-side tubular portion and the maximum value d1 and a minimum value d11 of the first rib diameter satisfy the relationship of d1 > d11 ≥ d3.

8. The ignition coil as set forth in claim 7, wherein:
the joint part further has a straight-shaped intermediate tubular portion formed between the main tubular portion and the proximal-side tubular portion; and
an outer diameter d4 of the intermediate tubular portion and the maximum value d2 and a minimum value d21 of the second rib diameter satisfy the relationship of d2 > d21 ≥ d4.

9. The ignition coil as set forth in claim 8, wherein the outer diameter d3 of the distal-side tubular portion and the outer diameter d4 of the intermediate tubular portion satisfy the relationship of d4 > d3.
